(19) United States
(12) Patent Application Publication
(10) Pub. No.: US 2003/0139207 A1
(43) Pub. Date: Jul. 24, 2003

(54) Wireless communication device and method of switching power supply

(76) Inventor: Masazumi Yamazaki, Kanagawa (JP)

Correspondence Address: STEVENS DAVIS MILLER & MOSHER, LLP, 1615 L STREET, NW, SUITE 850, WASHINGTON, DC, 20036, US

(21) Appl. No.: 10/296,472

(22) PCT Filed: Feb. 20, 2001
(86) PCT No.: PCT/JP01/01199

(51) Int. Cl. H04M 1/00

(52) U.S. Cl. 455/573; 455/572

(57) ABSTRACT

When a detection signal which indicates that a computer 103 is driven by external power supply 107 is not sent from a power supply detector 222 to power supply controller 203 through a detection signal transmission interface 212, by switching control of the power controller 203, a wireless communication apparatus 101 will be driven by a built-in battery in the wireless communication apparatus.

### TECHNICAL FIELD

The present invention relates to a wireless communication apparatus and a method of switching power supplies, and particularly, the present invention relates to a wireless communication apparatus used as connected to a computer apparatus such as a personal computer and a method of switching power supplies.

### BACKGROUND ART

When a portable computer apparatus such as a notebook computer performs data communication by wireless, typically, a wireless communication apparatus is connected to the computer through a PCMCIA interface or such provided in the computer. In such case, normally, the wireless communication apparatus is fed electric power from the power supply of the computer through the above interface or such.

However, conventional wireless communication apparatus have the following problem. That is, a conventional wireless communication apparatus is fed electric power from the power supply of a computer and thus driven. So when the computer is in mobile use driven by its built-in battery, this built-in battery needs to feed electric power to both the computer and the wireless communication apparatus. As a consequence, if the computer in mobile use performs data communication by wireless, consumption of the built-in battery increases, which derives the problem of a shortened driving time of the computer.

Particularly in recent years, wireless communication apparatus that have bigger circuit scales than conventional wireless communication apparatus and that are capable of high-speed data communication have been on demand in order to perform communication of large-volume data such as image and, in particular, moving pictures, and hence a tendency of increasing power consumption. So, there has been the problem of further shortened driving times of computers.

### SUMMARY OF THE INVENTION

The present invention aims to provide a wireless communication apparatus and a method of switching power supplies that without losing the convenience of portability prevent a computer's driving time from becoming short.

To achieve the above object, according to the present invention, a wireless communication apparatus is equipped with a dedicated battery inside that drives the wireless communication apparatus, and the wireless communication apparatus is driven using its dedicated battery without using a computer's built-in battery.

### BRIEF DESCRIPTION OF DRAWINGS

FIG. 1 is an apparatus configuration diagram illustrating a setting condition of a wireless communication apparatus and a computer apparatus according to Embodiment 1 of the present invention;

FIG. 2 is a block diagram showing a schematic configuration of a wireless communication apparatus and a computer apparatus according to Embodiment 1 of the present invention;

FIG. 3A is a block diagram showing a schematic configuration of a power controller section in a wireless communication apparatus according to Embodiment 1 of the present invention;

FIG. 3B is a block diagram showing a schematic configuration of a power controller section in a wireless communication apparatus according to Embodiment 1 of the present invention;

FIG. 4 is a block diagram showing a schematic configuration of a wireless communication apparatus and a computer apparatus according to Embodiment 2 of the present invention;

FIG. 5 is a block diagram showing a schematic configuration of a wireless communication apparatus and a computer apparatus according to Embodiment 3 of the present invention; and

FIG. 6 is a block diagram showing a schematic configuration of a wireless communication apparatus and a computer apparatus according to Embodiment 4 of the present invention.

### BEST MODE FOR CARRYING OUT THE INVENTION

With reference to the accompanying drawings now, embodiments of the present invention will be described in detail below.

(Embodiment 1)

A wireless communication apparatus according to the present embodiment is equipped with a dedicated power supply inside that drives the wireless communication apparatus, and when a computer is driven by a built-in power supply in the computer, the wireless communication apparatus is driven using its built-in power supply.

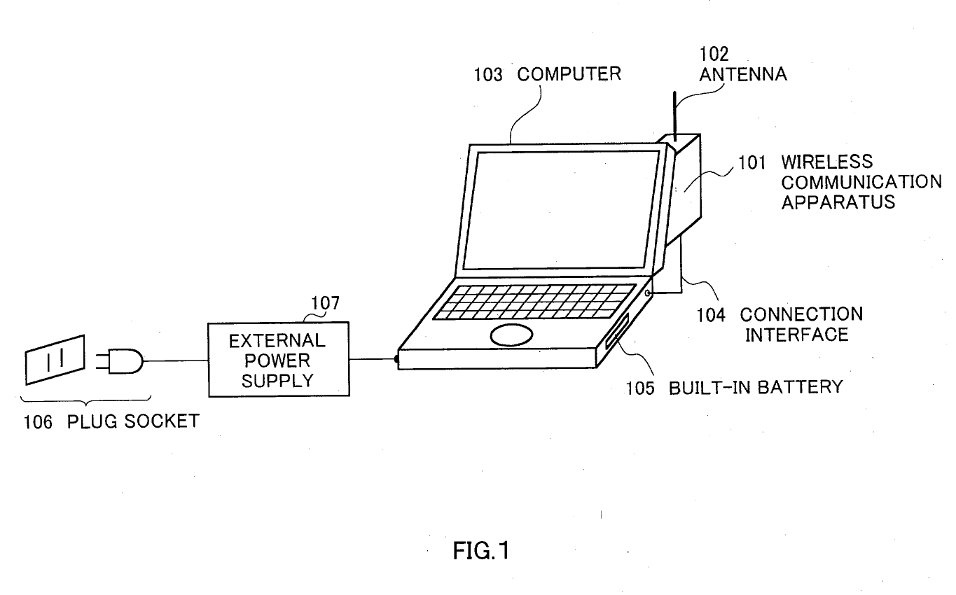

A wireless communication apparatus and a method for switching power supplies according to Embodiment 1 of the present invention will be described below. FIG. 1 is an apparatus configuration diagram illustrating a setting condition of a wireless communication apparatus and a computer apparatus according to Embodiment 1 of the present invention.

In FIG. 1, wireless communication apparatus 101 comprising antenna 102 is connected to portable computer 103 such as a notebook computer through connection interface 104. In addition, wireless communication apparatus 101 is fixed, for example, on the back of computer 103 and used.

Computer 103 comprises computer built-in battery 105 and is driven by means of external power supply 107 when plug socket 106 is plugged, while driven by means of computer built-in battery 105 when plug socket 106 is unplugged.

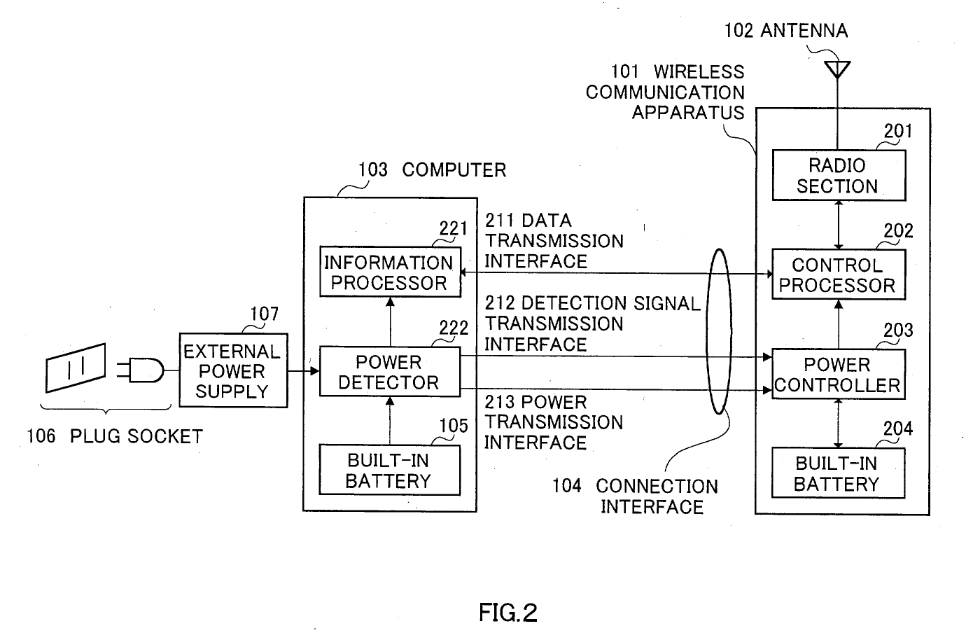

Next, a configuration of wireless communication apparatus 101 and computer 103 will be described. FIG. 2 is a block diagram showing a schematic configuration of a wireless communication apparatus and a computer apparatus according to Embodiment 1 of the present invention.

In wireless communication apparatus 101, radio section 201 performs predetermined radio processing and modulation/demodulation processing upon data received/transmitted through antenna 102.

Control processor 202 converts the received data into a computer-readable data format and thereafter transmits the converted data to computer 103. In addition, control processor 202 receives from computer 103 data that is to be transmitted and converts the data format. In addition, control processor 202 performs various controls and processings of wireless communication apparatus 101.

Power supply controller 203 performs switching control with the power supply used to drive wireless communication apparatus 101. The configuration of power supply controller 203 will be described later.

Built-in battery 204 is a dedicated power supply fixed inside wireless communication apparatus 101 driving wireless communication apparatus 101.

Connection interface 104 which connects wireless communication apparatus 101 and computer 103 is composed of data transmission interface 211, detection signal transmission interface 212, and power transmission interface 213.

Data transmission between wireless communication apparatus 101 and computer 103 is performed via data transmission interface 211. Through detection signal transmission interface 212, detection signals which indicate that computer 103 is driven using external power supply 107 are sent from computer 103 to wireless communication apparatus 101. Moreover, through power transmission interface 213, wireless communication apparatus 101 is fed electric power from computer 103.

On the other hand, in computer 103, information processor 221 performs various processings upon data transmitted from wireless communication apparatus 101 through data transmission interface 211. In addition, information processor 221 performs various processings upon data that is input into computer 103 and thereafter transmits this data to wireless communication apparatus 101 through data transmission interface 211.

Power supply detector 222 performs power supply switching control by way of detecting the condition of power feeding to computer 103 and controlling a switch in power supply detector 222.

Built-in battery 105 is a power supply used to drive computer 103 when plug socket 106 is unplugged.

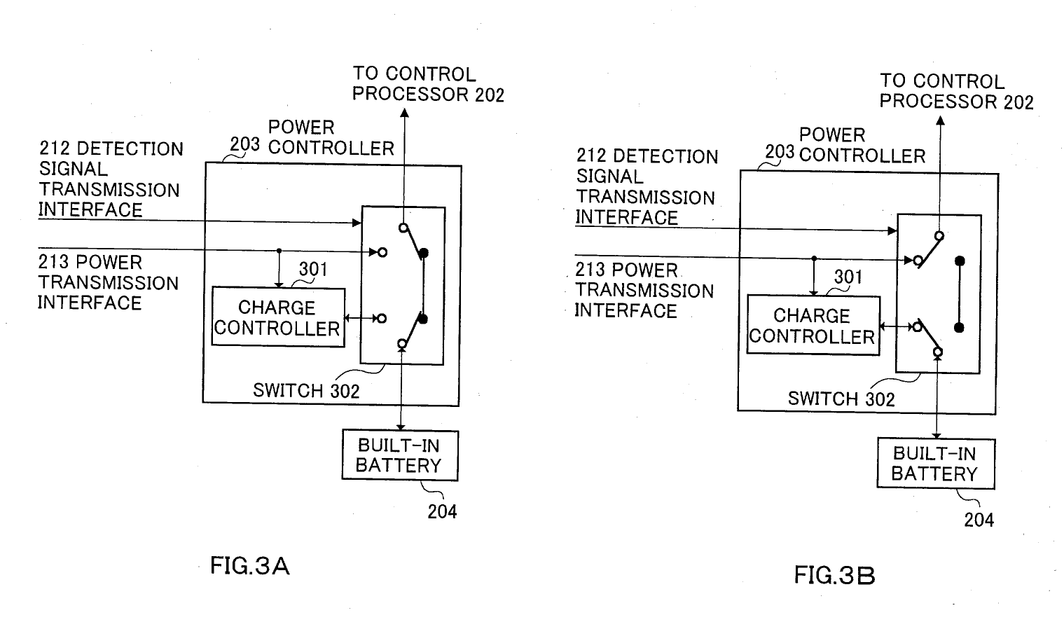

Next, a configuration of power supply controller 203 will be described. FIG. 3A and FIG. 3B are block diagrams each showing a schematic configuration of a power controller section in a wireless communication apparatus according to Embodiment 1 of the present invention.

In power supply controller 203, charge controller 301 performs control in such a way that built-in battery 204 is charged at a predetermined adequate charge level.

Changeover switch 302 operates in accordance with detection signals transmitted from electric power supply detector 222 and switches power supplies for use while wireless communication apparatus 101 is in operation.

Next, the operation of a wireless communication apparatus and a computer having the above configuration will be described.

In computer 103, when plug socket 106 is unplugged and there is no power feeding from power external power supply 107, power supply detector 222 connects itself to built-in. battery 105 by controlling the switch in power supply detector 221 so that information processor 221 can be driven by means of built-in battery 105. In this case, no detection signal is sent from power supply detector 222 to changeover switch 302.

In wireless communication apparatus 101, when no detection signal is sent thereto through detection signal transmission interface 212, changeover switch 302 switches to the black-circle side as illustrated in FIG. 3A. By this means built-in battery 204 and control processor 202 are connected, so that, when computer 103 is driven by built-in battery 105, wireless communication apparatus 101 is driven by built-in battery 204 as its power supply. As a result, the power of battery 105 is not consumed to drive wireless communication apparatus 101.

On the other hand, power supply detector 222, when detecting that plug socket 1056 is plugged and computer 103 is fed electric power from external power supply 107, sends detection signals to changeover switch 302 through detection signal transmission interface 212 while there is power feeding from external power supply 107. In this case, electric power supply detector 222 connects external power supply 107 and electric power transmission interface 213 by controlling the switch in electric power supply detector 222.

Furthermore, in this case, electric power supply detector 222 controls the switch provided therein and connects external power supply 107 and information processor 221 so that information processor 221 can be driven by external power supply 107.

In wireless communication apparatus 101, when the above detection signals are sent to changeover switch 302, changeover switch 302 switches to the white-circle side as illustrated in FIG. 3B. By this means power transmission interface 213 and control processor 202 are connected, so that, when computer 103 is fed electric power from external power supply 107, wireless communication apparatus 101 as well is fed electric power from external power supply 107 and thus driven.

In addition, when changeover switch 302 switches to the white-circle side as shown in FIG. 3B, electric power transmission interface 213 and built-in battery 204 are connected via charge controller 301, and built-in battery 204 is charged by the power supplied from external power supply 107. Then, charge controller 301 monitors the charge level of built-in battery 204 and, when the charge volume reaches a preset adequate level, blocks power feeding to built-in battery 204.

As thus described, according to the wireless communication apparatus and method of switching power supplies of the present embodiment, a wireless communication apparatus is equipped with a dedicated battery inside that drives the wireless communication apparatus and driven by using its own built-battery when a computer apparatus is driven by a power supply built in the computer, so that there is no need to use the power supply built in the computer to drive the wireless communication apparatus. Therefore, even if a wireless communication apparatus is connected to a computer while the computer is driven by a power supply built in the computer, it is still possible to prevent the computer's driving time from becoming short. In addition, a wireless communication apparatus is equipped with a built-in battery and can be driven without receiving power from an external power supply, so that the convenience of portability of the wireless communication apparatus will not be lost.

(Embodiment 2)

A wireless communication apparatus according to the present embodiment differs from Embodiment 1 starting a computer upon reception of data.

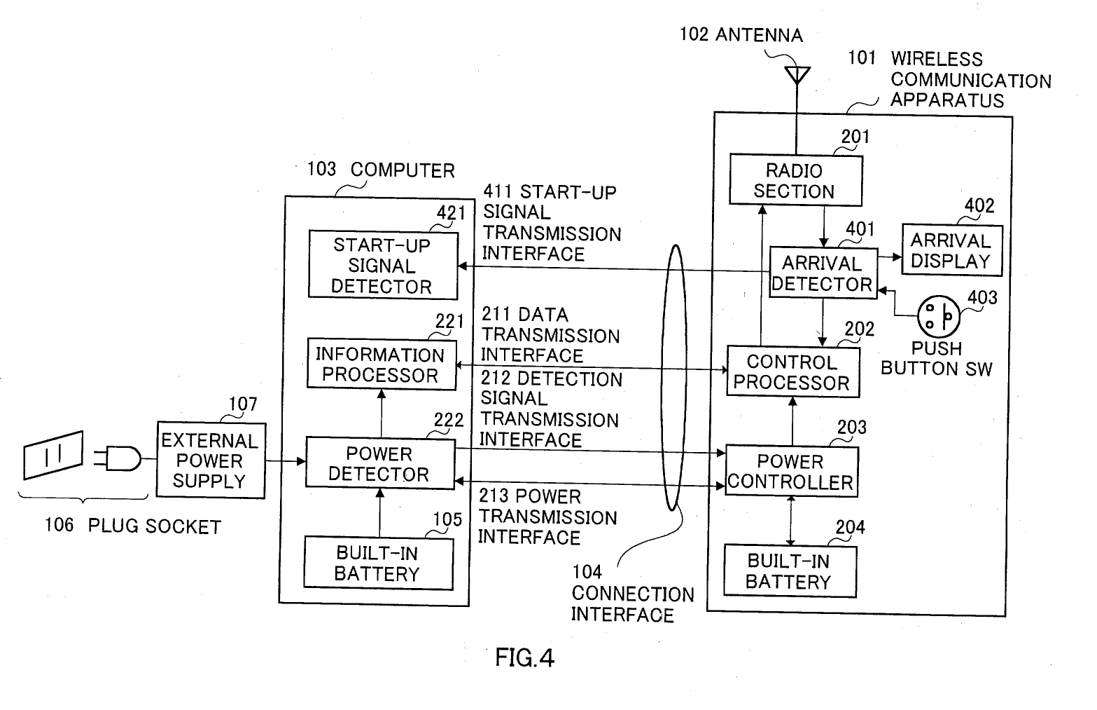

A wireless communication apparatus and a method of switching power supplies according to Embodiment 2 will be described below with reference to FIG. 4. FIG. 4 is a block diagram showing a schematic configuration of a wireless communication apparatus and a computer apparatus according to Embodiment 2 of the present invention. Parts identical with Embodiment 1 are assigned the same codes, and their detailed explanations are omitted.

Upon receiving data through antenna 102, radio section 201 outputs the data to reception detector 401.

While data is output from radio section 201, reception detector 401 outputs a signal that gives notice to reception display 402 to the effect that wireless communication apparatus 101 has received data, and outputs this output data to control processor 202.

Reception display 402 is an indicating light consisting of LED and such that turns on upon reception of the above notification signal. Therefore, a user of computer 103 is able to recognize reception of data even when computer 103 is turned off.

With reception display 402 turned on, the user of computer 103 recognizes that wireless communication apparatus 101 has received data, and presses push-button 403, thereby instructing reception detector 401 to generate a computer start-up signal.

Following the above instruction, reception detector 401 generates a computer start-up signal and sends this start-up signal to start-up signal detector 421 through start-up signal transmission interface 411.

In case computer 103 is turned off, following the above start-up signal, start-up signal detector 421 starts computer 103.

Incidentally, such configuration is also possible where reception detector automatically generates the computer start-up signal while data is output to radio section 201. In this case, push-button switch 403 is unnecessary.

Moreover, such configuration is also possible where, in case a computer is not using an external power supply as its power supply and furthermore the computer's built-in battery has not reached a preset charge level, the computer is driven by a built-in battery in a wireless communication apparatus.

In this case, in computer 103, when start-up signal detector 421 detects a start-up signal, power supply detector 222 detects the condition of the power supply in computer 103. That is, power supply detector 222 checks as to whether or not computer 103 is fed electric power from external power supply 107 and whether or not the charge level of built-in battery 105 has reached a preset charge level.

Then, in case computer 103 is not fed electric power from external power supply 107 and furthermore the charge level of built-in battery 105 has not reached a preset charge level, power supply detector 222 sends a detection signal to power supply controller 203 through detection signal transmission interface 212. Following this detection signal, power supply controller 203 uses built-in battery 204 and drives computer 103.

Such configuration makes it possible to drive a computer even when the computer is not using an external power supply and when, furthermore, a built-in battery in the computer has not reached a preset charge level.

As thus described, according to the wireless communication apparatus and method of switching power supplies of the present embodiment, a computer is started upon reception of data, so that the computer's power consumption can be saved. Therefore, when a computer is driven by a power supply built in the computer, the computer's driving time can be extended.

(Embodiment 3)

A wireless communication apparatus according to the present embodiment differs from Embodiment 2 in having processing functions for e-mail and such in addition to data transmission/reception functions.

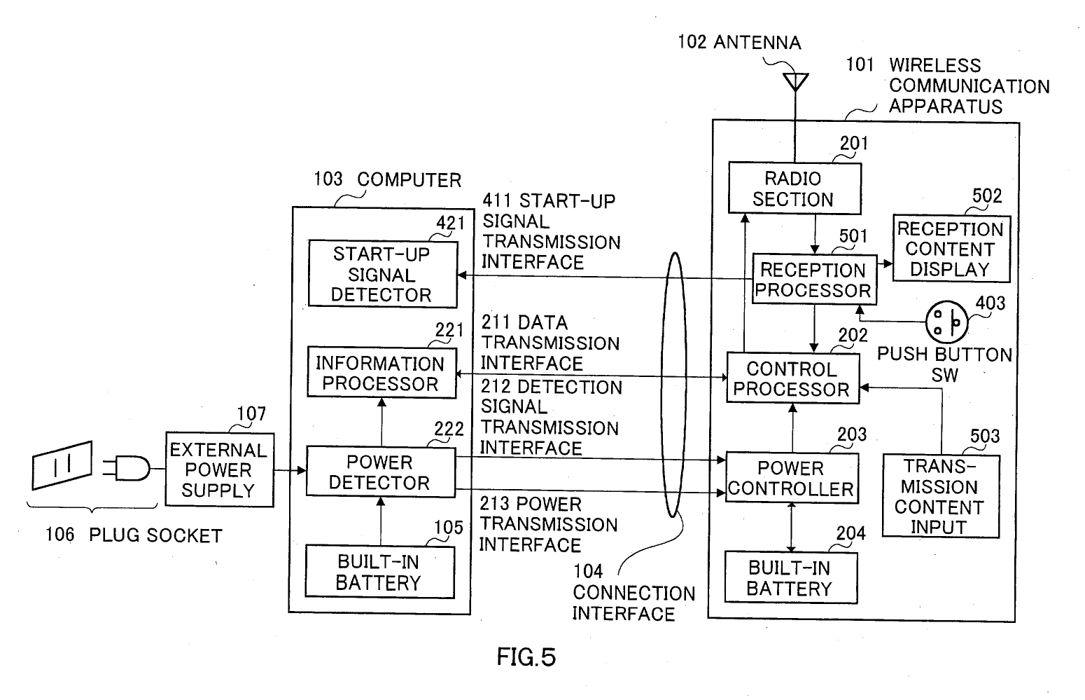

A wireless communication apparatus and a method of switching power supplies according to Embodiment 3 will be described below with reference to FIG. 5. FIG. 5 is a block diagram showing a schematic configuration of a wireless communication apparatus and a computer apparatus according to Embodiment 3 of the present invention. Parts identical with Embodiment 2 are assigned the same codes, and their detailed explanations are omitted.

Upon receiving data through antenna 102, radio section 201 outputs the data to reception processor 501.

Reception processor 501 has an e-mail reception function for instance, and if the data output from radio section 201 is e-mail, reception processor 501 displays the data of the e-mail title and the body text on reception content display 502 consisting of a liquid crystal display screen and such and outputs the data other than the title and the body text (e.g., data of an attachment file and image data pasted in the body text of e-mail) to control processor 202. In addition, when there is data other than the title and the body text, reception processor 501 notifies reception content display to the effect thereof.

When the data output from radio section 201 is not e-mail, reception processor 501 displays on reception content display 502 only to the effect of reception of the data.

Control processor 202 transmits the data other than the title and the body text to information processor 221 through data transmission interface 211.

The user of computer 103 can check e-mail titles and the body text on reception content display 502, and so when there is no data that accompanies e-mail other than titles and the body text, the user of computer 103 does not have to start computer 103.

Reception content display 502 displays to the effect that there is data other than titles and the body text, the user of computer 103 presses push-button 403 only when desiring to process this data, thereby instructing reception processor 501 to generate a computer start-up signal. Following this instruction, reception processor 501 generates a computer start-up signal and sends this start-up signal to start-up signal detector 421 through start-up signal transmission interface 411.

In case computer 103 is turned off, following the above start-up signal, start-up signal detector 421 starts computer 103. By this means it is possible to process the data other then titles and the body text in computer 103.

Moreover, wireless communication apparatus 101 comprises transmission content input 503. So, without starting computer 103, the user of computer 103 can input e-mail titles and the body text into wireless communication apparatus 101 through the use of transmission content input 503. The data input in transmission content input 503 is output to control processor 202 and processed.

In addition, in case wireless communication apparatus 101 has the e-mail processing function, there is no need to connect wireless communication apparatus 101 to computer 103, and it is still possible to input/output and transmit/receive e-mail titles and the body text by wireless communication apparatus 101 alone. Given the above, if connection interface 104 is one that can be attached to/detached from wireless communication apparatus 101 or computer 103, it will be possible to use wireless communication apparatus 101 as a mobile terminal apparatus for e-mail only.

As thus described, by the wireless communication terminal and method of switching power supplies of the present embodiment, given processing functions for e-mail in addition to data transmission/reception functions, e-mail can be viewed without starting a computer. So, when a computer is driven by a power supply built in the computer, the computer's driving time can be further extended compared to Embodiment 2. Moreover, a wireless communication apparatus by itself can be used as a mobile terminal apparatus, thereby enhancing convenience on the part of the user of the wireless communication apparatus.

Incidentally, like Embodiment 2, such configuration is also possible where, when a computer is not using an external power supply and furthermore a built-in battery in the computer has not reached a preset charge level, the computer is driven by a built-in battery for driving a wireless communication apparatus.

(Embodiment 4)

A wireless communication apparatus according to the present embodiment differs from Embodiment 3 in that it is connected with a computer by non-contact connection interface.

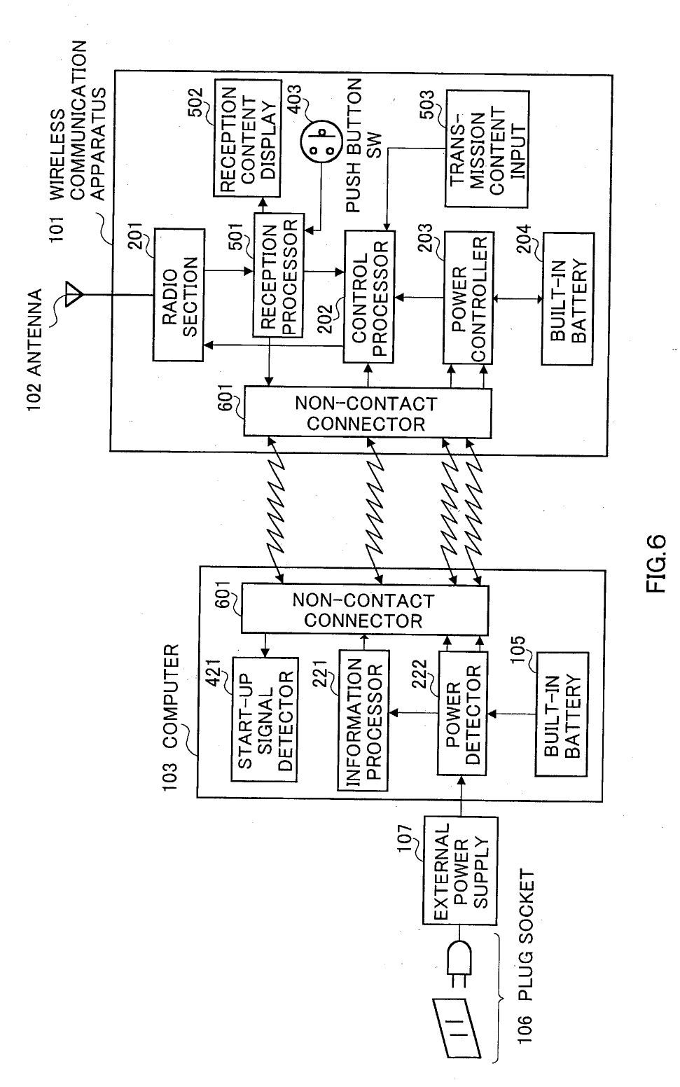

A wireless communication apparatus and a method of switching power supplies according to Embodiment 4 of the present invention will be describe below with reference to FIG. 6. FIG. 6 is a block diagram showing a schematic configuration of a wireless communication apparatus and a computer apparatus according to Embodiment 4 of the present invention. Parts identical with Embodiment 3 are assigned the same codes, and their detailed explanations are omitted.

Wireless communication apparatus 101 and computer 103 each comprise non-contact connector 601, which is an interface having no mechanical connector portion such as a connection connector, and are connected by means of these non-contact connectors 601's. These non-contact connectors 601's as connection means are connected by means of, for example, weak radio waves, electromagnetic induction, and light.

As thus described, by the wireless communication apparatus and method of switching power supplies according to the present embodiment, a wireless communication apparatus is connected to a computer by non-contact connection interface, thereby making it easy to connect/separate the wireless communication apparatus and the computer compared to Embodiment 3, and thereby enhancing convenience on the part of the user of the wireless communication apparatus. In addition, since a wireless communication apparatus is connected to a computer by non-contact connection interface, it is possible to prevent loose connection that results from wear and tear of connection connectors, thereby increasing the reliability of data transmission between the wireless communication apparatus and the computer.

Incidentally, wireless communication apparatus according to Embodiment 1 through Embodiment 4 can be connected to stationary computers for use.

As described above, the present invention makes it possible to prevent a computer's driving time from becoming short without losing the convenience of portability.

The present specification is based on Japanese Patent Application No. HEI11-242618 filed on Aug. 30, 1999, entire content of which is expressly incorporated herein for reference.

1. A wireless communication apparatus used as connected to a computer apparatus, said wireless communication apparatus comprising:
a built-in battery for driving said wireless communication apparatus, and
a switch controller that switches a power supply for said wireless communication apparatus between said built-in battery for driving said wireless communication apparatus and a power supply of said computer apparatus.

2. The wireless communication apparatus according to claim 1, wherein when a detection is made that said computer apparatus is in use of a battery built in said computer apparatus as a power supply, said switch controller performs a control so as to use said built-in battery for driving said wireless communication apparatus as a power supply for driving said wireless communication apparatus.

3. The wireless communication apparatus according to claim 1, wherein when a detection is made that said computer apparatus is in use of an external power supply as a power supply, said switch controller performs a control so as to use said external power supply as a power supply for driving said wireless communication apparatus.

4. The wireless communication apparatus according to claim 1, wherein when a detection is made that said computer apparatus is in use of an external power supply as a power supply, said switch controller performs a control so as to charge said built-in battery for driving said wireless communication apparatus by using said external power supply.

5. The wireless communication apparatus according to claim 1, further comprising:
an arrival detector that upon detecting a reception of data starts said computer apparatus; and
a display that displays to the effect of the reception of data.

6. The wireless communication apparatus according to claim 5, further comprising:
a power supply controller that, when upon starting said computer apparatus a detection is made that said computer apparatus is not in use of an external power supply as a power supply and that a battery built in said computer apparatus has not reached a predetermined charge level, performs a control so as to drive said computer apparatus through a use of said built-in battery for driving said wireless communication apparatus.

7. The wireless communication apparatus according to claim 1, further comprising:
a data processor that processes data relating to at least one of services provided through wireless communication;
a display that displays a content of said data; and
an input that is for inputting said data.

8. The wireless communication apparatus according to claim 1, further comprising a connector that exchanges data and signals with said computer apparatus.

9. A method of switching power supplies, wherein, as a power supply for a wireless communication apparatus used as connected to a computer apparatus,
a battery built in said wireless communication apparatus is used when said computer apparatus is driven by a battery built in said computer apparatus, and
an external power supply is used when said computer apparatus is driven by said external power supply.
